(19) United States
(12) Patent Application Publication
(10) Pub. No.: US 2010/0310083 A1
(43) Pub. Date: Dec. 9, 2010

(54) ELECTRONIC DEVICE WITH NOISE-SUPPRESSION SYSTEM

(75) Inventor: Gerhard Sonnde, Bad Aibling (DE)

Correspondence Address: DITTHAVONG MORI & STEINER, P.C., 918 Prince Street, Alexandria, VA, 22314, US

(73) Assignee: Rohde & Schwarz GmbH & Co. KG, Muenchen (DE)

(21) Appl. No.: 12/797,149

(22) Filed: Jun. 9, 2010

(30) Foreign Application Priority Data
Jun. 9, 2009 (DE) 10 2009 024 343.7

(51) Int. Cl. G10K 11/16

(52) U.S. Cl. 381/71.1

(57) ABSTRACT

An electronic device with at least one ventilator unit and at least one housing part with at least one ventilation opening. The electronic device includes a noise-suppression system with at least one microphone for registering noise vibrations for the output of vibration signals. The noise-suppression system further includes at least one processor unit for the reception of the vibration signals, for the determination of control signals dependent upon the vibration signals and for the output of the control signals. The noise-suppression system furthermore includes at least one electro-mechanical converter for the reception of the control signals and for the application onto the housing part of forces corresponding to the control signals and for the targeted formation of the housing-part vibrations.

### CROSS-REFERENCE TO RELATED APPLICATION

The present application claims priority to German Patent Application No. 10 2009 024 343.7, filed on Jun. 9, 2009, the entire contents of which are herein incorporated by reference.

### BACKGROUND OF THE INVENTION

1. Field of the Invention

The invention relates to an electronic device with noise-suppression system.

2. Discussion of the Background

Patent specification DE 691 31 170 T2 discloses a system for the active control and suppression of sound, which originates from one or more noise sources. The system comprises means for enclosure, which are provided with several openings and enclose one or more noise sources. Furthermore, the system comprises one or more loudspeaker means, which are used to eliminate sound, which is generated by the noise sources. Moreover, the system comprises microphone means, which are used to receive and then convert sound into electrical signals. Moreover, the system comprises control means, which are connected to the loudspeaker means and are used to receive signals from the residual microphone means. Microphones are used for the perception of the vibrations. Loudspeakers are used for the suppression of the vibrations. In each case, the perception and suppression of vibrations occur by means of sound. The sound originating from the vibration of a sound source is suppressed with sound. However, an active formation of a vibration of an interface between the device and its environment, for example, a housing, for external noise suppression, is not disclosed. Accordingly, a space-saving, active external-noise suppression is not disclosed.

### SUMMARY OF THE INVENTION

Accordingly, the object of the invention is to provide an electronic device with effective, active external-noise suppression.

The invention relates to an electronic device with at least one ventilator unit and at least one housing part with at least one ventilation opening. The electronic device according to the invention provides a noise-suppression system with at least one microphone for the registration of sound vibrations and for the output of vibration signals. The electronic device according to the invention further comprises at least one processor unit for the reception of the vibration signals, for the determination of control signals dependent upon the vibration signals and for the output of the control signals. The electronic device according to the invention comprises, in particular, at least one electro-mechanical converter for the reception of the control signals and for the application to the electronic device of forces for the targeted formation of housing-part vibrations corresponding to the control signals.

The microphone converts sound vibrations, which are generated by the electronic device and which occur in particular in the region of the ventilation opening, into electrical signals-vibration signals. The sound vibrations, which are generated by the electronic device, can also be caused, for example, by housing-part vibrations. In this manner, noises output by the electronic device can be registered and mapped. The noises or respectively vibrations mapped onto electrical vibration signals are registered by the processor unit and further processed to form electrical control signals. The electrical control signals are received by the electro-mechanical converter of the processor unit and converted into force patterns. The force patterns are used for the excitation of at least one housing part. Through this excitation, vibrations of the electronic device, in particular of the housing part, can be generated or respectively suppressed—but, in this case, are formed in a targeted manner for noise suppression. Accordingly, the noises, which are output by the electronic device can be minimised.

By preference, the electro-mechanical converter is disposed on the at least one housing part. In this manner, the first electro-mechanical converter can suppress vibrations, which occur in the direct environment of the housing part, in a particularly simple manner.

By preference, the electro-mechanical converter is attached directly to the at least one housing part in the region of the ventilation opening. Accordingly, the electro-mechanical converter can mechanically excite the housing to form vibrations in a particularly simple manner, where the sound to be suppressed is output. Accordingly, the sound generated by the targeted excitation of the housing, which is in phase opposition to the sound generated by the device, and the device sound cancel one another out close to the ventilation opening. Since this is the principal sound source of a device, the overall radiated sound energy is reduced.

At the same time, the electro-mechanical converter preferably suppresses vibrations of the at least one housing part, which without excitation would lead to the generation of sound. In this manner, a noise suppression of a principal noise source is made possible. Accordingly, the electronic device becomes significantly quieter.

By preference, the electro-mechanical converter comprises at least one first and one second piezoelectric element. The second piezoelectric element can be excited by means of electrical signals, for example, the control signals of the processor unit, to form mechanical vibrations. The excitation of mechanical vibrations of the piezoelectric element is used for the mechanical excitation of the housing part by the piezoelectric element and therefore ultimately to form acoustic excitations of the environment of the electronic device.

By preference, the electro-mechanical converter provides at least one piezoelectric element group. Through the piezoelectric element group, the housing part and/or the environment of the electronic device can be excited in a particularly favourable manner. As a result, noises of the electronic device can be suppressed in a particularly effective manner.

By preference, the second electro-mechanical converter comprises at least one second piezoelectric element matrix. As a result, noises of the electronic device can be suppressed even more effectively. The form of such a matrix can, in this context, be specially adapted to a ventilation-opening mesh or can at least surround the ventilation opening.

By preference, a spectral analysis of the vibration signals can be implemented by the processor unit in order to determine control signals from the vibration signals. Through the spectral analysis, frequencies, which participate in a significant manner in the development of noise, can be perceived and suppressed in a targeted manner.

### BRIEF DESCRIPTION OF THE DRAWINGS

A preferred embodiment of the invention is explained in greater detail in the description below on the basis of the drawings. The drawings are as follows:

FIG. 1 shows a schematic presentation of an exemplary embodiment of an electronic device according to the invention.

### DETAILED DESCRIPTION OF EXEMPLARY EMBODIMENTS OF THE INVENTION

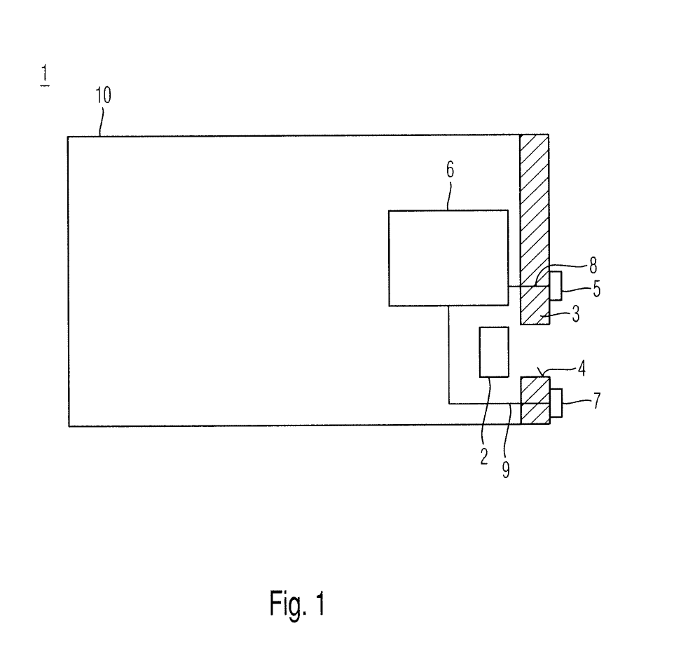

FIG. 1 shows an electronic device 1 according to the invention. The electronic device 1 according to the invention comprises a ventilator unit 2, which comprises at least one part of a complete ventilation device with, for example a ventilation motor and/or a ventilator, a housing part 3 of a housing 10 and a ventilation opening 4. The electronic device 1 further comprises a noise-suppression system with a microphone 5, an processor unit 6 and an electro-mechanical converter 7. The microphone 5 is connected via a first connection 8 to the processor unit 6. The electro-mechanical converter 7 is connected via a second connection 9 to the processor unit 6.

The microphone 5 registers sound vibrations emitted from the electronic device 1, especially from the housing part 3 or the housing 10. The sound vibrations emitted from the electronic device 1 can also be caused by housing-part vibrations or airborne-sound vibrations, which are generated in the interior of the housing. Furthermore, the microphone 5 determines electrical vibration signals dependent upon these vibrations. The electrical vibration signals map the sound emitted from the electronic device 1 in the region of the ventilation opening 4, especially the vibrations dependent upon the housing part 3 or the housing 10. Accordingly, the electrical vibration signals contain information about housing-part vibrations and other sound vibrations, which are generated by the electronic device 1, especially by the housing part 3 or the housing 10. The microphone 5 outputs the determined vibration signals via the first connection 8 to the processor unit 6. In turn, the processor unit 6 receives the vibration signals and determines control signals dependent upon the vibration signals. The control signals are used for the control of the second electro-mechanical converter 7 in phase opposition to the registered sound. The control of the electro-mechanical converter 7 is used for an active-noise suppression, with which the electronic device 1 is quietened relative to the outside. For the control of the electro-mechanical converter 7, the processor unit 6 outputs the control signals via the second connection 9 to the electro-mechanical converter 7. The electro-mechanical converter 7 receives the control signals and applies to the electronic device 1, especially to the housing part 3 or the housing 10, forces corresponding to the control signals. The vibration pattern of the housing part 3 or the housing 10 generated in this manner is formed in a targeted manner for the noise suppression. The vibrations of the housing part 3 or of the housing 10 can be suppressed directly or also excited in a targeted manner to form given vibrations in order to generate active-noise cancellation. In this manner, sound waves, which originate in the ventilator unit and/or the ventilation opening, that is to say, without the participation of the housing part 3 or the housing 10, can also be neutralised by means of active-noise cancellation, like housing vibrations resulting, for example, from ventilator vibration.

The microphone 5 is disposed on the housing part 3, in the example, externally.

However, the arrangement can also be made internally in the same manner as that of the electro-mechanical converter 7.

The electro-mechanical converter 7 is disposed directly on the at least one housing part 3 on the ventilation opening. Accordingly, the former can generate forces, which suppress vibrations, which are generated or emitted by the electronic device 1 or by the ventilator unit 2 and/or the housing part 3 and/or the housing 10 in the region of the ventilation opening 4. These forces preferably act at least partially on the housing part 3 or the housing 10. The strongest sound source of the device is the ventilation opening. Sound originating primarily from ventilator noises is emitted here. Through the excitation of the housing by means of the electro-mechanical converter 7, an active-noise cancellation can now be generated in a targeted manner in this region. The noise level resulting from the superimposition of sound and active-noise cancellation is accordingly significantly reduced.

In the exemplary embodiment presented, the electro-mechanical converter is attached directly to the housing part 3. Accordingly, the electro-mechanical converter 7 can mechanically excite the housing part 3 or the housing 10, directly, that is to say, without detour via sound waves as in the prior art. Through the electro-mechanical converter 7, vibrations of the housing part 3 or of the housing 10 can be suppressed directly, that is to say without detour via sound waves, or indirectly, that is to say, by means of sound waves.

In the simplified exemplary embodiment presented, the electro-mechanical converter 7 is a piezoelectric element. In other exemplary embodiments, the second electro-mechanical converter 7 comprises a piezoelectric element group with several piezoelectric elements. Accordingly, forces can be applied and vibrations can be excited, formed and/or suppressed in a spatially targeted manner. The second piezoelectric element group is preferably formed as a second piezoelectric element matrix.

The processor unit 6 preferably implements a spectral analysis of the vibration signals from the vibration signals of the microphone in order to determine the control signals for the second electro-mechanical converter 7, that is to say, for the piezoelectric element, the piezoelectric element group and/or the piezoelectric element matrix.

The sound-generating vibrations of the housing part 3 or the housing 10 in the region of the ventilation opening are registered by the microphone. These are then effectively suppressed through the direct excitation of the housing part 3 with a counter-vibration.

The invention is not restricted to the exemplary embodiment presented. On the contrary, individual features of the exemplary embodiments can also be advantageously combined with one another.

1. An electronic device with at least one ventilator unit and at least one housing part, in which at least one ventilation opening is formed,
wherein the electronic device comprises a noise-suppression system with at least one microphone for the registration of sound vibrations and for the output of vibration signals, at least one processor unit for the determination and output of control signals dependent upon the vibration signals and at least one electro-mechanical converter for the application to the housing part of forces corresponding to the control signals and for the targeted formation of housing part vibrations.

2. The electronic device according to claim 1,
wherein the microphone is disposed on the at least one housing part.

3. The electronic device according to claim 2,
wherein the microphone is disposed on the at least one housing part directly in the region of the ventilation opening.

4. The electronic device according to claim 1,
wherein the electro-mechanical converter is disposed on the at least one housing part.

5. The electronic device according to claim 4,
wherein the second electromechanical converter is attached directly to the at least one housing part and surrounds the ventilation opening.

6. The electronic device according to claim 1,
wherein vibrations of the at least one housing part can be suppressed by the electro-mechanical converter.

7. The electronic device according to claim 1,
wherein the electro-mechanical converter comprises at least one second piezoelectric element.

8. The electronic device according to claim 1,
wherein the second electro-mechanical converter comprises at least one second piezoelectric element group.

9. The electronic device according to claim 1,
wherein the second electro-mechanical converter comprises at least one second piezoelectric element matrix.

10. The electronic device according to claim 1,
wherein for the determination of control signals from the vibration signals, a spectral analysis of the vibration signals can be implemented by the processor unit.

11. The electronic device according to claim 2,
wherein the electro-mechanical converter is disposed on the at least one housing part.

12. The electronic device according to claim 3,
wherein the electro-mechanical converter is disposed on the at least one housing part.

13. The electronic device according to claim 2,
wherein vibrations of the at least one housing part can be suppressed by the electro-mechanical converter.

14. The electronic device according to claim 3,
wherein vibrations of the at least one housing part can be suppressed by the electro-mechanical converter.

15. The electronic device according to claim 2,
wherein the electro-mechanical converter comprises at least one second piezoelectric element.

16. The electronic device according to claim 3,
wherein the electro-mechanical converter comprises at least one second piezoelectric element.

17. The electronic device according to claim 2,
wherein the second electro-mechanical converter comprises at least one second piezoelectric element group.

18. The electronic device according to claim 3,
wherein the second electro-mechanical converter comprises at least one second piezoelectric element group.

19. The electronic device according to claim 2,
wherein the second electro-mechanical converter comprises at least one second piezoelectric element matrix.

20. The electronic device according to claim 2,
wherein for the determination of control signals from the vibration signals, a spectral analysis of the vibration signals can be implemented by the processor unit.
